(19) United States
(12) Patent Application Publication
(10) Pub. No.: US 2011/0292859 A1
(43) Pub. Date: Dec. 1, 2011

(54) MOBILITY MANAGEMENT METHOD AND SYSTEM FOR MULTICAST AND BROADCAST SERVICES

(75) Inventors: Tricci So, San Diego, CA (US); Jerry Chow, San Diego, CA (US); Chu Li, Shenzhen (CN); Song Jianquan, Shenzhen (CN)

(73) Assignee: ZTE (USA) Inc., Iselin, NJ (US)

(21) Appl. No.: 13/130,570

(22) PCT Filed: Nov. 24, 2009
(86) PCT No.: PCT/US2009/065759

§ 371 Date: Aug. 15, 2011

Related U.S. Application Data
(60) Provisional application No. 61/117,918, filed on Nov. 25, 2008.

(51) Int. Cl. H04W 4/06

(52) U.S. Cl. 370/312

(57) ABSTRACT

A system is disclosed for performing a mobile station handover while continuing a multicast and broadcast service (MCBCS). The system includes a transceiver module transmitting from the mobile station multicast and broadcast service (MBS) zone criteria, including a list of one or more potential target base stations, to a serving base station, if a target base station is not in the same MBS zone as the serving base station. A handover request is made to one or more of the potential target base stations from the serving base station, determined based on the MBS zone criteria, where the MBS zone criteria includes an MCBCS continuity policy of the mobile station. A target base station is then selected, from the list of one or more potential target base stations, that satisfies the MBS zone criteria, and a handover process is performed to the target base station.

### CROSS-REFERENCE TO RELATED APPLICATIONS

This application claims priority to U.S. Provisional Patent Application No. 61/117,918 filed on Nov. 25, 2008, entitled “MCBCS Mobility Management Method and System,” the contents of which are incorporated by reference herein in their entirety.

### FIELD

The present invention relates generally to wireless communications, and more particularly to mobility management for multicast and broadcast service(s) (MCBCS), as described in an Institute of Electrical and Electronics Engineers (IEEE) 802.16 communication system protocol.

### BACKGROUND

In the current IEEE 802.16Rev2/D9 draft specification for Air Interface for Broadband Wireless Access Systems that includes support for Multicast Broadcast Services (MCBCS) (incorporated herein by reference), support for seamless service continuity of MCBCS reception for mobile stations (MSs) as they move between Base Stations (BSs) within an MCBCS Zone leverages the daisy-chain mechanism provided by MBS_DATA IE and the fact that the communications parameters associated with each MCBCS service flow are the required to be the same between BSs within the MBS Zone.

An MBS Zone is comprised of one or more base stations (BSs) belonging to the same geographical region to which the BSs synchronize their downlink transmissions at least to the granularity of an air interface frame with the same data contents over the same or different frequencies to a set of target MSs or to any MS in that region. An MBS Zone is identified by an MBS Zone Identifier (MBS Zone ID) and an MBS service flow is associated with a Multicast Connection Identifier (MCID) that identifies the air interface connection over which the data of the MBS service flow are transmitted within a BS.

Support for seamless service continuity between BSs in adjoining (or neighboring) MBS Zones has been included via the broadcasting of the mapping of MBS Zone ID and MCID from their values in the current MBS Zone to their corresponding values in the neighboring MBS Zone and any differences in the alignment of MBS data transmissions for the same MBS service flows between the neighboring MBS Zones.

As the MBS Zone ID and multicast connection identifier (MCID) remain the same within an MBS Zone, the MS can refer to the same burst of the downlink (DL) subframes that are synchronously transmitted by the BSs which belong to the same MBS Zone to receive the MBS DL transmission. In addition, the MBS_DATA_IE which is part of the MBS_MAP message provides the support to daisy-chain the data transmissions of the given MBS service across multiple DL frames which are not immediately following each other consecutively. As described in the IEEE 802.16 specification, the design of the MBS_DATA_IE supports 2 levels of granuity for the daisy chaining:
Inter MBS-MAP messages; and
Inter MBS bursts.
   The programming of the MBS_DATA_IE may be agnostic to the MS who is operating in the active, sleep or idle mode, for example, while the MS is traversing within the same MBS zone. With the MBS_DATA_IE support, there is no need to search for the MBS_MAP_IE in every frame to locate the MBS burst for the given MBS Zone.

Once the MS is attached to an access service network (ASN) and is registered with one or more MBS services over an anchor ASN, a portion or all of the MCBCS related context information (e.g. MCID(s), MBS Zone ID(s), Anchor MBS Proxy, MBS Distribution DPF, MCBCS service policy etc.) together with other MS context information may be preserved and accessible by a serving handover function that is associated with the MS.

### SUMMARY

The presently disclosed embodiments are directed to solving one or more of the problems presented in the prior art, described above, as well as providing additional features that will become readily apparent by reference to the following detailed description when taken in conjunction with the accompanying drawings.

One embodiment of the present disclosure is directed to a method of managing a mobile station handover while continuing a multicast and broadcast service (MCBCS). The method includes transmitting from the mobile station multicast and broadcast service (MBS) zone criteria, including a list of one or more potential target base stations, to a serving base station, if the target base station is not in the same MBS zone as the serving base station; initiating a handover request to one or more of the potential target base stations from the serving base station, determined based on the MBS zone criteria; selecting a target base station that satisfies the MBS zone criteria; and performing a handover process to the target base station.

Another embodiment is directed to a system for performing a mobile station handover while continuing an MCBCS. The system includes a transceiver module transmitting from the mobile station MBS zone criteria, including a list of one or more potential target base stations, to a serving base station, if a target base station is not in the same MBS zone as the serving base station. A handover request is made to one or more of the potential target base stations from the serving base station, determined based on the MBS zone criteria, where the MBS zone criteria includes an MCBCS continuity policy of the mobile station. A target base station is then selected, from the list of one or more potential target base stations, that satisfies the MBS zone criteria, and a handover process is performed to the target base station.

Yet another embodiment is directed to method of performing a network-initiated handover of a mobile station while maintaining an MCBCS. The method includes transmitting a handover request message from a serving base station to the mobile station, including a list of one or more potential target base stations, wherein the one or more potential target base stations are determined based on MBS zone criteria of the mobile station; selecting a target base station from the one or more potential target base stations by the mobile station, based on the MBS zone criteria; and performing a handover process to the selected target base station.

Yet another embodiment is directed to a system for performing a network-initiated handover of a mobile station while maintaining an MCBCS. The system includes a transceiver module transmitting a handover request message from a serving base station to the mobile station, including a list of one or more potential target base stations, wherein the one or more potential target base stations are determined based on MBS zone criteria of the mobile station. The system further includes a processing module selecting a target base station from the one or more potential target base stations by the mobile station, based on the MBS zone criteria; and a handover module performing a handover process to the selected target base station.

Yet another embodiment is directed to a method of performing an uncontrolled handover of a mobile station while maintaining an MCBCS. The method includes if the mobile station leaves a serving base station and is handed over to a target base station before receiving a list of one or more potential target base stations from the serving base station, requesting by the target base station mobile station context from the serving base station, wherein the one or more potential target base stations are determined based on MBS zone criteria; determining at the target base station, whether the target base station satisfies the MBS zone criteria; and transmitting MBS zone parameters to the mobile station, if the target base station satisfies the MBS zone criteria.

Yet another embodiment is directed to a system for performing an uncontrolled handover of an MCBCS. The system includes a requesting module, if the mobile station leaves a serving base station and is handed over to a target base station before receiving a list of one or more potential target base stations from the serving base station, requesting by the target base station mobile station context from the serving base station, wherein the one or more potential target base stations are determined based on MBS zone criteria. The system further includes a processing module determining at the target base station, whether the target base station satisfies the MBS zone criteria; and a transceiver module transmitting MBS zone parameters to the mobile station, if the target base station satisfies the MBS zone criteria.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following Figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is an illustration of an exemplary mobile radio channel operating environment, according to an embodiment.

FIG. 2 is an illustration of an exemplary communication system, according to an embodiment.

FIG. 3 is an illustration of an exemplary radio channel operating environment with a plurality of MBS zones grouped into MBS service groups, according to an embodiment.

FIG. 4 is a flow diagram illustrating the MS initiating the MBS handover (HO) Preparation phase and MBS HO Action phase, according to an embodiment.

FIG. 5 is a flow diagram illustrating the MS initiated MBS HO Action phase, according to an embodiment.

FIG. 6 is a flow diagram illustrating the MS initiated MBS HO Preparation phase, according to an embodiment.

FIG. 7 is a flow diagram illustrating an un-controlled MBS HO procedure, according to an embodiment.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

As used herein, the term “access service network” (ASN) includes without limitation any set of network functions that provide radio access to a mobile station.

As used herein, the term “mobile station” (MS) includes without limitation a station with mobile service intended to be used while in motion or during halts at unspecified points.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Embodiments of the invention are described herein in the context of one practical application, namely, communication between a base station and a plurality of mobile devices. In this context, the exemplary system is applicable to provide data communications between base station(s) and a plurality of mobile devices. Embodiments of the disclosure, however, are not limited to such base station and mobile device communication applications, and the methods described herein may also be utilized in other applications such as mobile-to-mobile communications, or wireless local loop communications. As would be apparent to one of ordinary skill in the art after reading this description, these are merely examples and the invention is not limited to operating in accordance with these examples. Assignment of resources within a frame to the data being carried can be applied to any digital communications system with data transmissions organized within a frame structure and where the full set of such resources within a frame can be flexibly divided according to portions of different sizes to the data being carried. Note that the functions described in the present disclosure may be performed by either a base station or a mobile station. A mobile station may be any user device such as a mobile phone, and a mobile station may also be referred to as user equipment (UE) or subscriber station (SS).

According to one embodiment, providing service continuity across multicast broadcast service (MBS) zones for mobile stations (MSs) in Idle mode can be done by allowing the current daisy-chaining of MBS bursts that exist within MBS Zones to operate in the entire service area where certain similar or the same MBS content is being delivered. Supporting this operation requires that MSs are aware of the content association between MBS Zones at the time the MS performs a handover or, in the case of Idle Mode, a preferred base station (BS) reselection. Therefore, this kind of neighbor cell MBS Zone association information needs to be provided to the current serving BS so that the MS has the information at the time of BS reselection.

According to an embodiment, such neighbor cell MBS Zone association information is provided in such a way that meets one or more of the following requirements:
1. Additional signaling overhead can be minimized in providing such association information over the breadth of the various MBS Zone deployment scenarios, such as with macro-diversity enabled and without, with scenarios where MBS Zone crossing may be more frequent (such as with sparse macro-diversity MBS Zones for higher order frequency reuse deployments in which MBS Zones may be defined on a carrier frequency basis with macro-diversity enabled), or less frequent (such as in single frequency macro-diversity deployments);
2. No impact to critical signaling (e.g., IEEE 802.16 MAPs); and/or
3. MBS zone transition is supported shortly after joining the service (e.g., information available either with an active MBS connection or not).

According to an embodiment, MBS service flows which may have the same geographic extent by virtue of being associated with a common set of MBS Zones and may require seamless service continuity across all MBS Zones within which the MBS service flows are made available, may be associated with a common MBS Service Group identified by an MBS Service Group Identifier (MBS Service Group ID). The association of MBS Service Group to MBS Zone can be defined by attaching the MBS Service Group ID to the appropriate MBS Zone identifier when the MBS Zone identifiers are made known to the MS via the data carrier detect (DCD) and neighbor advertisements, for example. If an MS has obtained the neighboring BS's MBS Zone identifier information, and thereby the associated MBS Service Group IDs, it may then know, before performing a handover, the MBS Zone identifiers that will allow the MBS content (that it is currently receiving) to be continued at the target BS by searching for MBS Zone identifiers that are associated with the MBS Service Groups that it is actively receiving.

MBSs provide an efficient method for concurrent transport of data common to a group of users using a common multicast content identifier (MCID). MBS service may be offered in the downlink only and may be coordinated and optionally synchronized among a group of BSs to allow macro-diversity. The service flows associated with MBS have certain QoS parameters and may require encryption performed using a globally defined sequence of Traffic Encryption Keys (TEKs). Since a multicast connection is associated with a service flow, it is associated with the QoS and traffic parameters for that service flow. All service flows that transmit similar MBS contents (e.g., multiple channels of video), created on any MS 104, may have the same service flow management encodings for QoS parameter set.

Service flows to carry MBS data are instantiated on individual MSs participating in the service while in Normal Operation. During such instantiation the MS learns the parameters that identify the service and associated service flows. Each BS capable of providing MBS service belongs to a certain MBS Zone, which is a set of BSs where the same MCID and same security association (SA) is used for transmitting the content of certain service flow(s), according to an embodiment. One or more MBS service flows may belong to the same MBS Service Group. One or more MBS Service Groups may be served via an MBS Zone. Within the MBS Zones comprising the geographic service area of the MBS Service Group, the same MBS contents may be transmitted over the same MCID and SA, and if applicable, the same logical channels for each MBS service flow belonging to the MBS Service Group. Seamless service continuity for MBS service flows within an MBS Service Group is provided within its geographic service area.

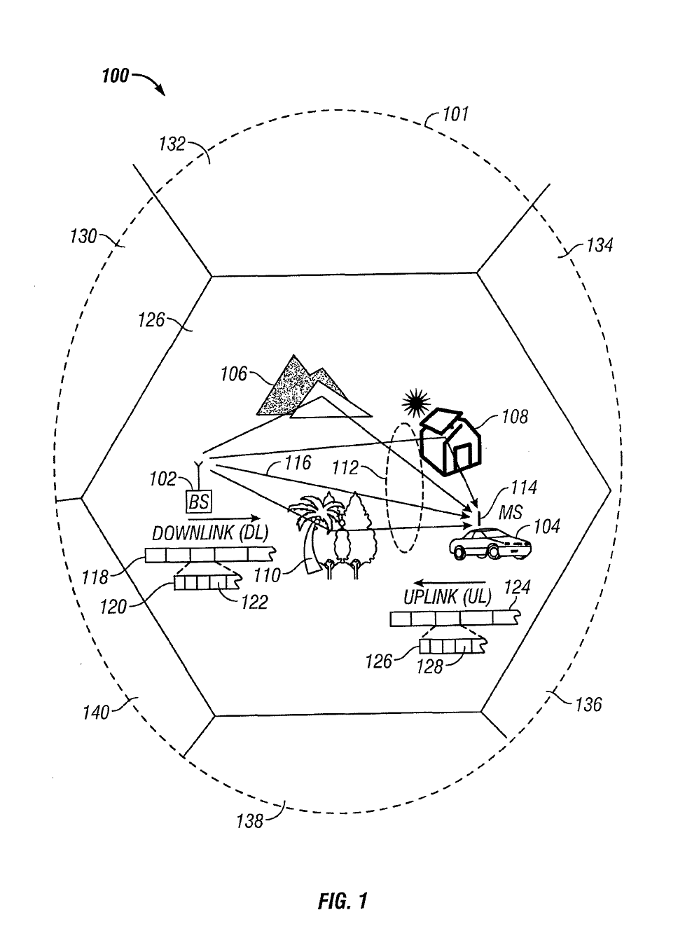

FIG. 1 illustrates a mobile radio channel operating environment 100, according to one embodiment of the present invention. The mobile radio channel operating environment 100 may include a base station (BS) 102, a mobile station (MS) 104, various obstacles 106/108/110, and a cluster of notional hexagonal MBS zones 126/130/132/134/136/138/140 overlaying a geographical area 101. Each MBS zone 126/130/132/134/136/138/140 may include any number of base stations operating at allocated bandwidths to provide adequate radio coverage to its intended users. For example, the base station 102 may operate at an allocated channel transmission bandwidth to provide adequate coverage to the mobile station 104. The exemplary mobile station 104 in FIG. 1 is an automobile; however mobile station 104 may be any user device such as a mobile phone. Alternately, mobile station 104 may be a personal digital assistant (PDA) such as a Blackberry device, MP3 player or other similar portable device. According to some embodiments, mobile station 104 may be a personal wireless computer such as a wireless notebook computer, a wireless palmtop computer, or other mobile computer devices.

The base station 102 and the mobile station 104 may communicate via a downlink radio frame 118, and an uplink radio frame 124 respectively. Each radio frame 118/124 may be further divided into sub-frames 120/126 which may include data symbols 122/124. In this mobile radio channel operating environment 100, a signal transmitted from a base station 102 may suffer from the operating conditions mentioned above. For example, multipath signal components 112 may occur as a consequence of reflections, scattering, and diffraction of the transmitted signal by natural and/or man-made objects 106/108/110. At the receiver antenna 114, a multitude of signals may arrive from many different directions with different delays, attenuations, and phases. Generally, the time difference between the arrival moment of the first received multipath component 116 (typically the line of sight component), and the last received multipath component (possibly any of the multipath signal components 112) is called delay spread. The combination of signals with various delays, attenuations, and phases may create distortions such as ISI and ICI in the received signal. The distortion may complicate reception and conversion of the received signal into useful information. For example, delay spread may cause ISI in the useful information (data symbols) contained in the radio frame 124.

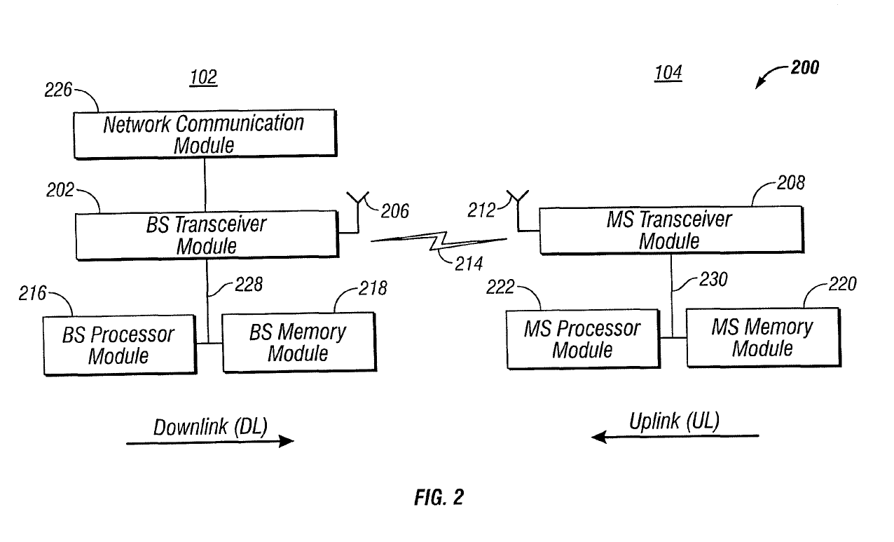

FIG. 2 shows an exemplary wireless communication system 200 for transmitting and receiving signals, in accordance with one embodiment of the present invention. The system 200 may include components and elements configured to support known or conventional operating features that need not be described in detail herein. In the exemplary embodiment, system 200 can be used to transmit and receive data symbols in a wireless communication environment such as the wireless communication environment 100 (FIG. 1). System 200 generally comprises a BS 102 with a BS transceiver module 202, a BS antenna 206, a BS processor module 216 and a BS memory module 218. System 200 generally comprises an MS 104 with an MS transceiver module 208, an MS antenna 212, an MS memory module 220, an MS processor module 222, and a network communication module 226. Of course both BS 102 and MS 104 may include additional or alternative modules without departing from the scope of the present disclosure.

Furthermore, these and other elements of system 200 may be interconnected together using a data communication bus (e.g., 228, 230), or any suitable interconnection arrangement. Such interconnection facilitates communication between the various elements of wireless system 200. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present invention.

In the exemplary system 200, the BS transceiver 202 and the MS transceiver 208 each comprise a transmitter module and a receiver module (not shown). Additionally, although not shown in this figure, those skilled in the art will recognize that a transmitter may transmit to more than one receiver, and that multiple transmitters may transmit to the same receiver.

In the particular example system depicted in FIG. 2, an “uplink” transceiver 208 includes a transmitter that shares an antenna with an uplink receiver. A duplex switch may alternatively couple the uplink transmitter or receiver to the uplink antenna in time duplex fashion. Similarly, a “downlink” transceiver 202 includes a receiver which shares a downlink antenna with a downlink transmitter. A downlink duplex switch may alternatively couple the downlink transmitter or receiver to the downlink antenna in time duplex fashion.

The mobile station transceiver 208 and the base station transceiver 202 are configured to communicate via a wireless data communication link 214. The mobile station transceiver 208 and the base station transceiver 202 cooperate with a suitably configured RF antenna arrangement 206/212 that can support a particular wireless communication protocol and modulation scheme. In the exemplary embodiment, the mobile station transceiver 208 and the base station transceiver 202 are configured to support industry standards such as the Third Generation Partnership Project Long Term Evolution (3GPP LTE), Third Generation Partnership Project 2 Ultra Mobile Broadband (3Gpp2 UMB), Time Division-Synchronous Code Division Multiple Access (TD-SCDMA), and Wireless Interoperability for Microwave Access (WiMAX), and the like. The mobile station transceiver 208 and the base station transceiver 202 may be configured to support alternate, or additional, wireless data communication protocols, including future variations of IEEE 802.16, such as 802.16e, 802.16m, and so on.

According to certain embodiments, the BS 102 controls the radio resource allocations and assignments, and the MS 104 is configured to decode and interpret the allocation protocol. For example, such embodiments may be employed in systems where multiple MSs 104 share the same radio channel which is controlled by one BS 102. However, in alternative embodiments, the MS 104 controls allocation of radio resources for a particular link, and could implement the role of radio resource controller or allocator, as described herein.

Processor modules 216/222 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. Processor modules 216/222 comprise processing logic that is configured to carry out the functions, techniques, and processing tasks associated with the operation of system 200. In practical embodiments the processing logic may be resident in the BS 102 and/or may be part of a network architecture that communicates with the BS transceiver 202.

The steps of a method or algorithm described in connection with the embodiments disclosed herein may be embodied directly in hardware, in firmware, in a software module executed by processor modules 216/222, or in any practical combination thereof. A software module may reside in memory modules 218/220, which may be realized as RAM memory, flash memory, ROM memory, EPROM memory, EEPROM memory, registers, a hard disk, a removable disk, a CD-ROM, or any other form of storage medium known in the art. In this regard, memory modules 218/220 may be coupled to the processor modules 218/222 respectively such that the processors modules 216/220 can read information from, and write information to, memory modules 618/620. As an example, processor module 216, and memory modules 218, processor module 222, and memory module 220 may reside in their respective ASICs. The memory modules 218/220 may also be integrated into the processor modules 216/220. In an embodiment, the memory module 218/220 may include a cache memory for storing temporary variables or other intermediate information during execution of instructions to be executed by processor modules 216/222. Memory modules 218/220 may also include non-volatile memory for storing instructions to be executed by the processor modules 216/220.

Memory modules 218/220 may include a frame structure database (not shown) in accordance with an exemplary embodiment of the invention. Frame structure parameter databases may be configured to store, maintain, and provide data as needed to support the functionality of system 200 in the manner described below. Moreover, a frame structure database may be a local database coupled to the processors 216/222, or may be a remote database, for example, a central network database, and the like. A frame structure database may be configured to maintain, without limitation, frame structure parameters as explained below. In this manner, a frame structure database may include a lookup table for purposes of storing frame structure parameters.

The network communication module 226 generally represents the hardware, software, firmware, processing logic, and/or other components of system 200 that enable bi-directional communication between base station transceiver 202, and network components to which the base station transceiver 202 is connected. For example, network communication module 226 may be configured to support interne or WiMAX traffic. In a typical deployment, without limitation, network communication module 226 provides an 802.3 Ethernet interface such that base station transceiver 202 can communicate with a conventional Ethernet based computer network. In this manner, the network communication module 226 may include a physical interface for connection to the computer network (e.g., Mobile Switching Center (MSC)).

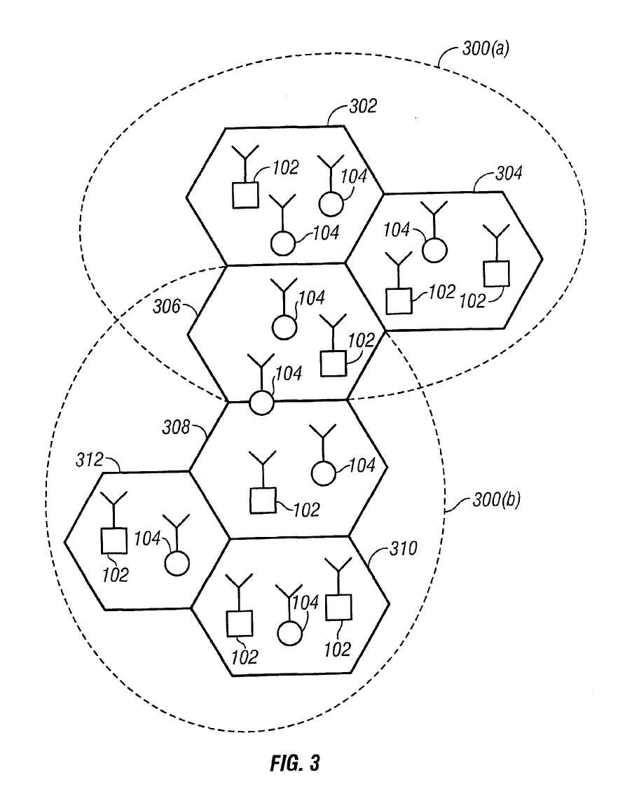

FIG. 3 is an illustration of an exemplary radio channel operating environment with a plurality of MBS zones grouped into MBS service groups (or MBS service areas), according to an embodiment. Within an MBS Zone, dependent upon whether it is macro diversity or frame-level coordination enabled within the MBS Zone, the MCBCS programming contents may not necessarily be contained in the MBS permutation zone at the exact location of the DL subframe, and the MCBCS programming contents may or may not always be scheduled at the same frame for both cases. As long as the MCID(s) and MBS Zone ID remain the same, the MS can retrieve the expected MCBCS programming contents through the support of the MBS_MAP_IE, MBS_MAP message and MBS DATA IE as described above.

Across MBS Zones, there are two options to choose from dependent upon the type of MBS services:
Option-1: maintaining the frame-level coordination to maximize service continuity; and
Option-2: basic zone switching without synchronization.

When the MS recognizes that it has crossed the MBS Zone boundary and the target BS 102 is no longer a part of the serving MBS Zone, the MS 104 may initiate the handover procedure in order to obtain the corresponding new target MBS Zone related parameters to resume the reception of the MCBCS downlink transmission, according to certain embodiments.

According to certain embodiments, inter-MBS Zone handover support may be only expected if the same MCBCS service is spanned across multiple MBS zones, which belong to the same MCBCS Transmission Zone, and particular service continuity is required. In addition, through either the pre-configuration or the event trigger (e.g. Session Start), the MBS zone neighbors may also be provided to the BS 102 for each MBS Zone that the BS 102 supports. MBS Zone neighbors include, for example, the immediate neighbor zone of the current serving MBS Zone for the given MCBCS service that has been provided to the MS, according to certain embodiments.

FIG. 3 depicts various MBS zones 302/304/306/308/310/312 grouped into MBS service groups 300 (or MBS service areas) (shown as 300(a) and 300(b)). For exemplary purposes, only two MBS service groups 300(a) and 300(b) are depicted; however, any number of MBS service groups may be available. MBS zones 302/304/306/308/310/312 can include any number of BSs 102 and MSs 104.

As shown in FIG. 3, MBS service group 300(a) includes MBS zones 302, 304 and 306, while MBS service group 300(b) includes MBS zones 306, 308, 310 and 312. According to the depicted embodiment, an MBS zone (e.g., 306) may be included in multiple MBS service groups 300(a) and 300(b). Of course in an MBS service group 300, the included MBS zones may be disjointed, and are not required to be in any particular type of cluster. MBS zones may be any shape and are depicted as hexagons for exemplary purposes.

For the intra or inter MBS Zones handover support, there are several basic scenarios to consider: MS 104-initiated controlled handover, BS 102-initiated Controlled handover and Un-controlled handover. Both intra-MBS Zone and inter-MBS Zone handover may be MS 104-initiated and BS-102-initiated.

While the MS 104 is in the active mode and the MS 104 has joined the MBS service, regardless of whether there is on-going MCBCS DL transmission or not, the MS 104 may continue to monitor the MOB_NBR_ADV to determine if the target preferred BS 102 belongs to the current MBS Zone. Prior to the handover preparation phase, if the target BS 102 supports the same MBS Zone ID as the current serving/anchor BS 102, the MS 104 recognizes that it is still within the same MBS zone. If there is on-going MCBCS DL transmission, the MS 104 may refer to part of or all the information in the DCD, DL_MAP, MBS_MAP_IE, and/or MBS_MAP messages as well as the MBS_DATA_IE to receive the MCBCS DL transmission. Within the same MBS Zone, the MS 104 can continue to receive the MCBCS programming contents without registering with other BSs 102 within that MBS Zone, according to certain embodiments.

Existing handover procedures for unicast service flow are not necessarily impacted by the intra-MBS Zone transition, except that the addition of the MBS related service parameters such as the MBS Zone ID, MCID(s) etc. can be included as part of the MS's 104 context to be passed on to the target BS(s) 102 by the serving BS 102, according to certain embodiments.

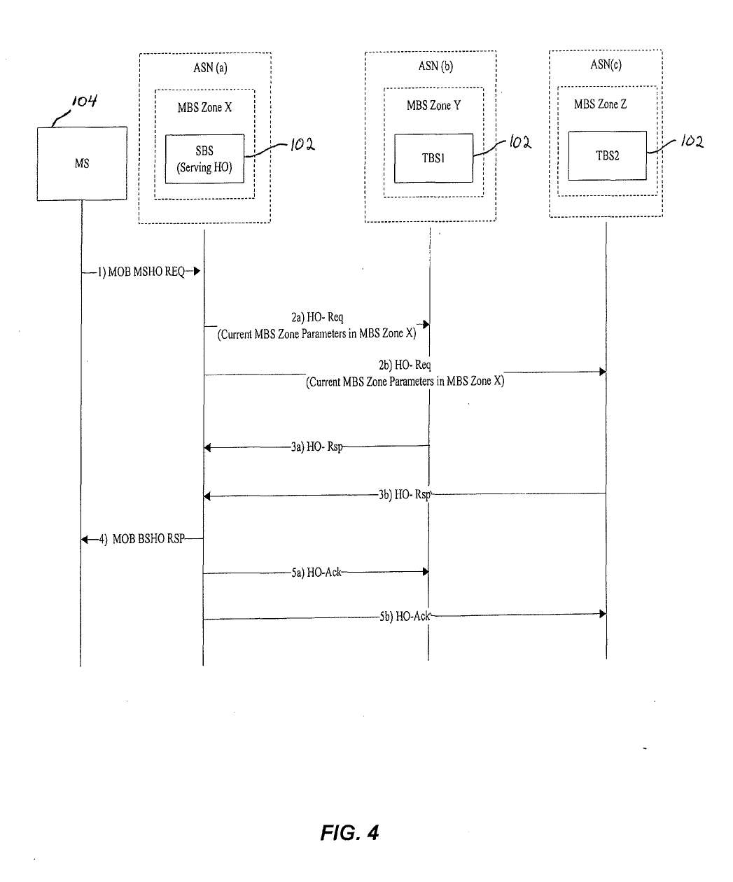

FIG. 4 is a flow diagram showing the MS 104 initiating the MBS handover (HO) Preparation phase and MBS HO Action phase. When the MS 104 recognizes that it is approaching or crossing an MBS Zone boundary (inter-MBS zone), as the target BS 102 is no longer part of the same serving MBS Zone of the MS 104, the MS 104 may perform the handover operation in order to obtain the corresponding new MBS Zone related parameters to resume the reception of the MCBCS downlink transmission.

According to certain embodiments, prior to the handover preparation phase, the MS 104 may examine the MBS Zone ID(s) of the target BS(s) 102 via the MOB_NBR_ADV message obtained from the serving/anchor BS 102 periodically. If the target BS 102 does not support the same serving MBS Zone, the MS 104 recognizes that it is approaching a different MBS Zone, and the MS 104 may trigger the handover procedure by issuing an MOB_MSHO_REQ message towards the serving BS 102 with the list of potential target BS(s) that meet the HO trigger criteria (e.g. relative CINR or RSSI threshold, etc.).

When the network receives the MOB_MSHO-REQ message from the MS 104, the serving BS 102 may include MBS Zone parameters (e.g. MBS Proxy ID, anchor MBS DPF ID, MCIDs, LCIDs, SAIDs, etc.) obtained from the MS 104 context and initiate one or more HO-Reqs to the potential target BSs 102. If service continuity is required for a particular MCBCS service, the serving BS 102 can select only the potential target BS 102 which supports the same MCBCS service, according to certain embodiments.

When the target BS 102 receives the HO-Req with the MS 104 context containing the MBS Zone parameters as well as the MBS Zone neighbor information from the serving BS 102, and if MCBCS service continuity is required, then, if the target BS 102 is part of the same MBS or it supports one or more of the target MBS Zone neighbors, and if the target BS 102 meets some or all other service criteria required by the MS 104, the target BS 102 responds to the serving BS 102 with a positive HO-RSP. Otherwise, the target BS 102 may respond to the serving BS 102 with a negative HO-RSP, according to certain embodiments.

Once the serving BS 102 examines one or more of the HO-RSPs from the target BSs 102, the serving BS 102 will then select the target BS 102 according to, at least in part, the requirement of the MCBCS service continuity policy. If the MCBCS service continuity is required and there is at least one target BS 102 that is part of the same MBS Zone or that supports one or more of the target MBS Zone neighbors, the serving BS 102 may include the selected target BS 102 in the MOB_BSHO-RSP to respond to the MS 104, according to certain embodiments. Otherwise, the serving BS 102 may reject the MOB_MSHO-REQ from the MS with a negative MOB_BSHO-RSP, for example.

If no target BS 102 can be identified in the MOB_BSHO-RSP, but there is a neighbor BS 102 of the serving BS that supports one of the MBS Zone neighbors, even though the neighbor BS 102 may not have been included in the original list of the target BSs 102 selected by the MS 104 in the prior MOB_MSHO-REQ, the serving BS 102 may suggest such a potential target BS 102 to be included the MOB_BSHO-REQ to be sent to the MS 104, according to certain embodiments. The MS 104 may or may not accept such a target BS 102 in the MOB_BSHO-REQ dependent on the MS's 104 RF sensitivity towards the proposed target BS 102 by the serving BS 102, for example.

When the MS 104 receives the MOB_BSHO-RSP from the serving BS 102 with the list of target BS(s) 102, the MS 104 may complete the handover preparation phase and proceed to the action phase of the handover operation.

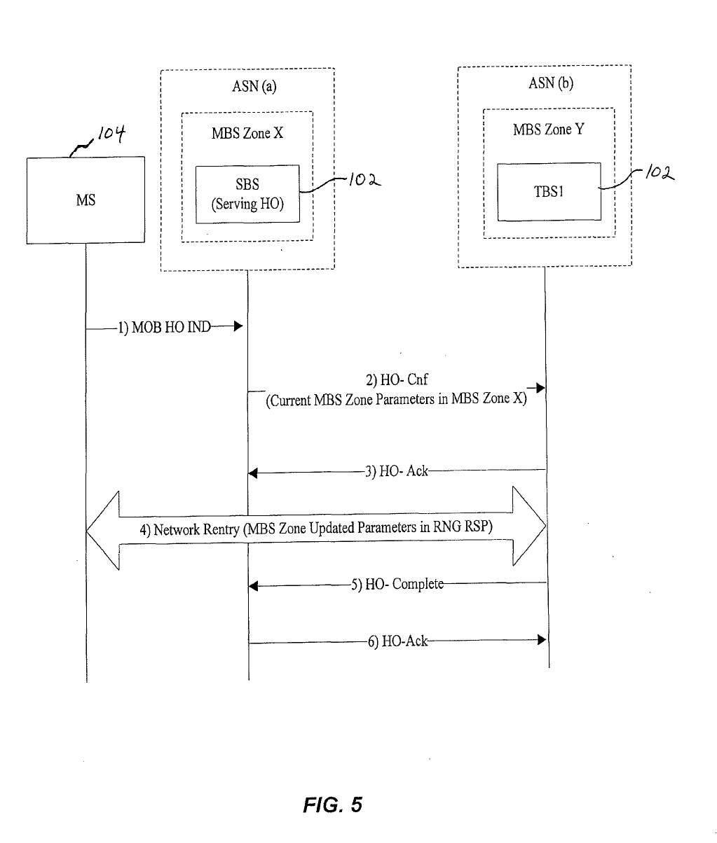

FIG. 5 is a flow diagram illustrating the MS 104 initiated MBS HO Action phase. Once the MS 104 selects the target BS 102 by sending the MOB_HO-IND, for example, to the serving BS 102, the MS 104 may then initiates the RNG-REQ towards the new serving BS 102. The target BS 102 may have been notified by the serving BS 102 that it has been selected by the MS 104, and the target BS 102 can include the updated MBS Zone parameters in the REG-RSP encoding TLV of the RNG-RSP to be responded to by the MS 104. Once the handover operation is completed, the MS 104 context can be updated with the new MBS Zone parameters according to the selected new serving BS 102, according to certain embodiments.

If the new serving BS 102 does not support the same MBS service, the MBS service will be disrupted and will not be continued. The handling and the reporting of the MBS service disruption is a local implementation design decision and various implementations may be used without departing from the scope of the present disclosure.

When the MS 104 receives the RNG-RSP with the updated MBS Zone parameters, the MS 104 can then resume the MCBCS programming contents reception by referring to the DCD, DL_MAP, MBS_MAP_IE, and/or MBS_MAP messages and the MBS_DATA_IE based on the procedures as described in the IEEE 802.16 specification, for example.

Network-initiated inter-MBS Zone controlled handover refers to, for example, when the MCBCS service continuity policy is required and, by referring to the MS 104 context as well as a BS 102 neighbor list of the current serving BS 102, the serving BS 102 recognizes the MS 104 is approaching a new MBS Zone which supports the same MBS services as the serving MBS Zone of the MS.

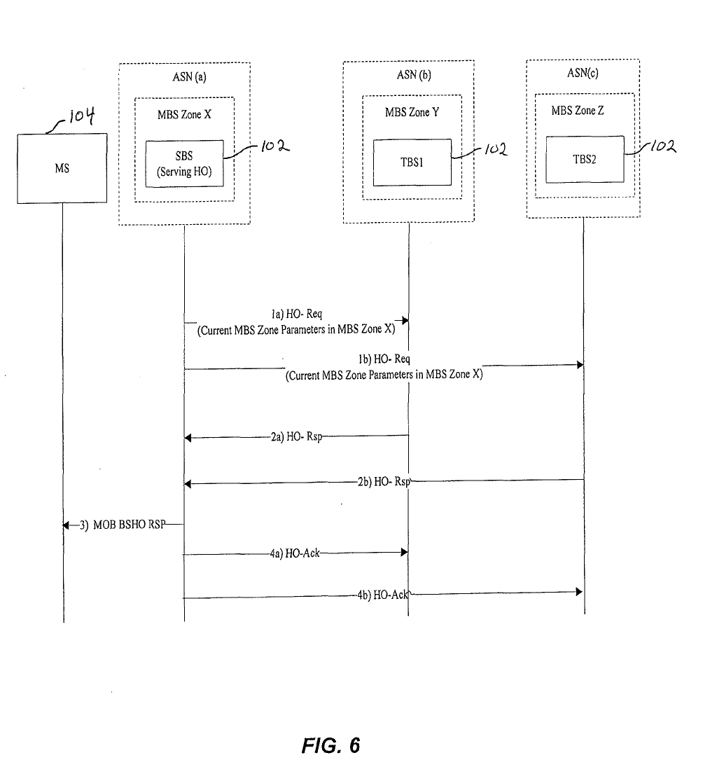

FIG. 6 is a flow diagram illustrating a network-initiated MBS HO Preparation phase, according to an embodiment. The serving BS 102 may initiate the MOB_BSHO_REQ to the MS 104 which includes the list of potential target BS(s) 102 that supports the same MCBCS service required by the MS 104. The serving BS 102 may proceed with the HO procedure preparation with the potential target BS(s) 102, according to certain embodiments.

When the MS 104 receives the MOB_BSHO-REQ from the serving BS 102 with the list of potential target BS(s) 102, the MS 104 can complete the handover preparation phase and proceed to the action phase of the handover operation.

Once the MS 104 selects the target BS 102 by sending the MOB_HO-IND to the serving BS 102, the MS 104 will then initiates the RNG-REQ towards the new serving BS 102. The new target BS 102, according to certain embodiments, may have been notified of being selected by the MS 104. The target BS 102 may include the updated MBS Zone parameters in the REG-RSP encoding TLV of the RNG-RSP sent to the MS 104. Once the handover operation is completed, the MS 104 context may be updated with the new MBS Zone parameters according to the selected new serving BS 102, according to certain embodiments.

When the MS 104 receives the RNG-RSP with the updated MBS Zone parameters, the MS 104 can then resume the MCBCS programming contents reception by referring to the DCD, DL_MAP, MBS_MAP_IE and/or MBS_MAP messages and the MBS_DATA_IE based on the procedures as described in the IEEE 802.16 specification, according to certain embodiments.

According to certain embodiments, the Network Initiated MBS Action Phase may be the same as the MS Initiated MBS Action Phase.

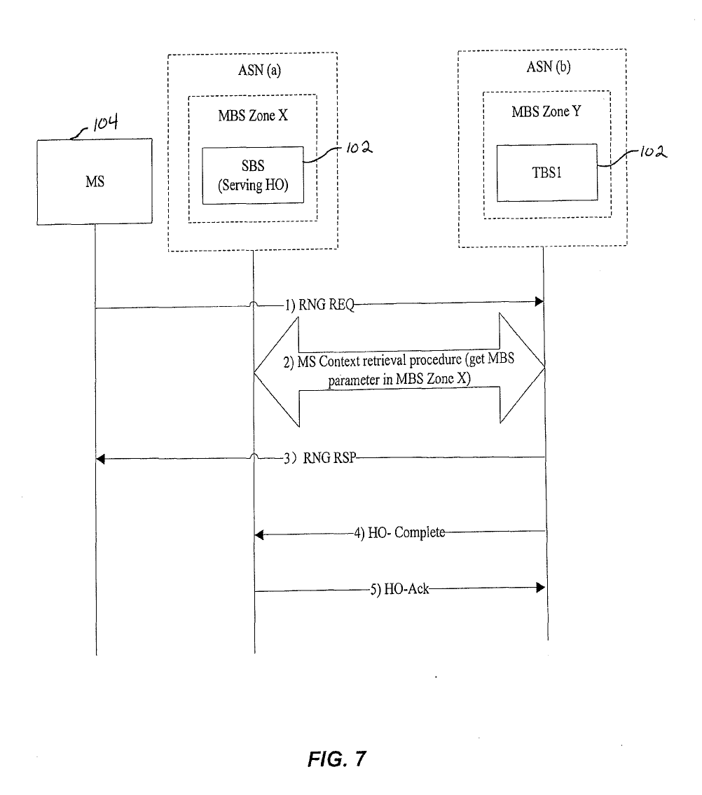

FIG. 7 is a flow diagram illustrating an uncontrolled inter-MBS zone HO procedure, according to an embodiment. If the MS 104 leaves the serving BS 102 before receiving MOB-BSHO_RSP but it succeeds in at least sending MOB-HO-ND with an indication of the target BS 102, this is considered uncontrolled HO. In the worst case scenario, the MS 104 may suddenly connect in the target BS 102 without any indication given to the target BS 102. This is considered as un-predictive HO.

When the new serving BS 102 receives a RNG-REQ from an MS 104, by referring to the old serving BS 102 in the RNG-REQ, the new serving BS 102 can request the MS 104 context of the MS 104 from the old serving BS 102. When the new serving BS 102 receives the MS 104 context from the old serving BS 102, with the list of the serving MBS Zone parameters, for example, the new serving BS 102 may then determine if it is part of the same MBS Zone or if it supports one of the target MBS Zone neighbors for the given MS 104.

If the new serving target BS 102 supports the same MCBCS service, however, in a different MBS Zone, the new serving BS 102 will then include the appropriate MBS Zone parameters in the REG-RSP encoding TLV of the RNG-RSP to be returned to the MS 104.

When the MS 104 receives the RNG-RSP with the updated MBS Zone parameters, the MS 104 can then resume the MCBCS programming contents reception by referring to the DCD, DL_MAP, MBS_MAP_IE and/or MBS_MAP messages and the MBS_DATA_IE based on the procedures as described in the IEEE 802.16 specification, according to certain embodiments.

As noted above, existing handover procedures for the unicast service flow are not impacted by the intra-MBS Zone transition, except that, for example, the addition of the MBS related service parameters such as the MBS Zone ID, MCID(s), etc. may be required to be included as part of the MS's 104 context to be passed on to the target BS(s) 102 by the serving BS 102.

In the case when the MS is approaching or crossing the MBS zone boundary, the MS 104 and the network may decide which handover policy should take the precedence—e.g. the unicast service criteria vs. the MBS service criteria.

In order to support the proper handover decision, the MCBCS service continuity indicator may be required to set the handover policy for the given MCBCS service at the ASN, according to certain embodiments.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

In this document, the terms “computer program product”, “computer-readable medium”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method of managing a mobile station handover while continuing a multicast and broadcast service (MCBCS), comprising:
transmitting from the mobile station multicast and broadcast service (MBS) zone criteria, including a list of one or more potential target base stations, to a serving base station, if a first target base station is not in the same MBS zone as the serving base station;
initiating a handover request to one or more of the potential target base stations from the serving base station, determined based on the MBS zone criteria;
selecting a target base station that satisfies the MBS zone criteria; and
performing a handover process to the target base station.

2. The method of claim 1, further comprising:
determining a MBS zone identification (ID) of the target base station, via a message sent from a serving base station; and
determining whether the target base station and the serving base station are in a same MBS zone, based on the message sent from the serving base station.

3. The method of claim 1, further comprising:
if no target base stations satisfy the MBS zone criteria, suggesting, by the serving base station, a potential target base station to be included in the list of one or more potential target base stations, if the potential target base station is a neighbor base station to the serving base station, wherein
the MBS zone criteria includes an MCBCS continuity policy of the mobile station.

4. The method of claim 1, further comprising:
updating MBS zone parameters at the mobile station, based on the MBS zone of the target base station.

5. The method of claim 1, wherein the MBS zone criteria includes an MCBCS continuity policy of the mobile station.

6. A system for performing a mobile station handover while continuing a multicast and broadcast service (MCBCS), comprising:
a transceiver module transmitting from the mobile station multicast and broadcast service (MBS) zone criteria, including a list of one or more potential target base stations, to a serving base station, if a target base station is not in the same MBS zone as the serving base station;
a processor module initiating a handover request to one or more of the potential target base stations from the serving base station, determined based on the MB S zone criteria;
a determination module selecting a target base station that satisfies the MBS zone criteria; and
a handover module performing a handover process to the target base station.

7. The system of claim 6, further comprising:
a processor module determining a MBS zone identification (ID) of the target base station, via a message sent from a serving base station, and determining whether the target base station and the serving base station are in a same MBS zone, based on the message sent from the serving base station.

8. The system of claim 6, further comprising:
if no target base stations satisfy the MBS zone criteria, a suggesting module suggesting a potential target base station to be included in the list of one or more potential target base stations, if the potential target base station is a neighbor base station to the serving base station, wherein
the MBS zone criteria includes an MCBCS continuity policy of the mobile station.

9. The system of claim 5, further comprising:
an updating module updating MBS zone parameters at the mobile station, based on the MBS zone of the target base station.

10. The system of claim 5, wherein the MBS zone criteria includes an MCBCS continuity policy of the mobile station.

11. A method of performing a network-initiated handover of a mobile station while maintaining a multicast and broadcast service (MCBCS), comprising:
transmitting a handover request message from a serving base station to the mobile station, including a list of one or more potential target base stations, wherein the one or more potential target base stations are determined based on multicast and broadcast service (MBS) zone criteria of the mobile station;
selecting a target base station from the one or more potential target base stations by the mobile station, based on the MBS zone criteria; and
performing a handover process to the selected target base station.

12. The method of claim 11, wherein the MBS zone criteria includes an MCBCS continuity policy of the mobile station.

13. The method of claim 11, further comprising:
updating MBS zone parameters at the mobile station, based on an MBS zone of the selected target base station.

14. The method of claim 11, wherein the target base station is in a different MBS zone than the serving base station.

15. A system for performing a network-initiated handover of a mobile station while maintaining a multicast and broadcast service (MCBCS), comprising:
a transceiver module transmitting a handover request message from a serving base station to the mobile station, including a list of one or more potential target base stations, wherein
the one or more potential target base stations are determined based on multicast and broadcast service (MBS) zone criteria of the mobile station;
a processing module selecting a target base station from the one or more potential target base stations by the mobile station, based on the MBS zone criteria; and
a handover module performing a handover process to the selected target base station.

16. The system of claim 14, wherein the MBS zone criteria includes an MCBCS continuity policy of the mobile station.

17. The system of claim 14, further comprising:
an updating module updating MBS zone parameters at the mobile station, based on an MBS zone of the selected target base station.

18. The system of claim 14, wherein the target base station is in a different MBS zone than the service base station.

19. A method of performing an uncontrolled handover of a mobile station while maintaining a multicast and broadcast service (MCBCS), comprising:
if the mobile station leaves a serving base station and is handed over to a target base station before receiving a list of one or more potential target base stations from the serving base station, requesting by the target base station mobile station context from the serving base station,
wherein the one or more potential target base stations are determined based on multicast and broadcast service (MBS) zone criteria;
determining at the target base station, whether the target base station satisfies the MBS zone criteria; and
transmitting MBS zone parameters to the mobile station, if the target base station satisfies the MBS zone criteria.

20. The method of claim 19, wherein the serving base station and the target base station are in different MBS zones.

21. The method of claim 19, further comprising:
updating MBS zone parameters at the mobile station, based on the MBS zone of the target base station; and
resuming the MCBCS at the mobile station.

22. A system for performing an uncontrolled handover of a mobile station while maintaining a multicast and broadcast service (MCBCS), comprising:
a requesting module, if the mobile station leaves a serving base station and is handed over to a target base station before receiving a list of one or more potential target base stations from the serving base station, requesting by the target base station mobile station context from the serving base station,
wherein the one or more potential target base stations are determined based on multicast and broadcast service (MBS) zone criteria;
a processing module determining at the target base station, whether the target base station satisfies the MBS zone criteria; and
a transceiver module transmitting MBS zone parameters to the mobile station, if the target base station satisfies the MBS zone criteria.

23. The system of claim 22, wherein the serving base station and the target base station are in different MBS zones.

24. The system of claim 22, further comprising:
an updating module updating MBS zone parameters at the mobile station, based on the MBS zone of the target base station; and
a MCBCS resuming module resuming the MCBCS at the mobile station.
